(19) United States
(12) Patent Application Publication
(10) Pub. No.: US 2012/0113147 A1
(43) Pub. Date: May 10, 2012

(54) METHOD OF OPERATING A DEVICE

(75) Inventors: Otso Juho Virtanen, Helsinki (FI); Sateesh Babu Kavuri, Bangalore (IN); Qi Ouyang, Helsinki (FI); Vivek Sekar, Helsinki (FI); Yonatan Kelib, Helsinki (FI); Jari Anttonen, Salo (FI); Kaj Markus Makela, Helsinki (FI)

(73) Assignee: NOKIA CORPORATION, Espoo (FI)

(21) Appl. No.: 13/182,676

(22) Filed: Jul. 14, 2011

(30) Foreign Application Priority Data
Jul. 15, 2010 (IN) 2010/CHEN/2010

(51) Int. Cl. G09G 5/00

(52) U.S. Cl. 345/650; 345/649

(57) ABSTRACT

A method of operating a device comprises defining a plurality of selectable menu options, causing the device to display an arrangement of a subset of the selectable menu options and causing the device to rotate the arrangement such that one or more of the plurality of selectable menu options forming part of the subset are ceased to be displayed and such as to cause the device to display one or more of the plurality of selectable menu options that do not form part of the subset of the selectable menu options.

### RELATED APPLICATION

This application is cross referenced to and claims priority from India Application No. 2010/CHE/2010 filed on Jul. 15, 2010 which is herein incorporated by reference in its entirety.

### FIELD OF THE INVENTION

The present invention relates to a method of operating a device.

### BACKGROUND OF THE INVENTION

Menu systems are commonly employed in mobile devices to allow users to navigate through and select options.

### SUMMARY OF THE INVENTION

A first aspect of the invention provides a method of operating a device, comprising defining a plurality of selectable menu options, causing the device to display an arrangement of a subset of the selectable menu options; and causing the device to rotate the arrangement such that one or more of the plurality of selectable menu options forming part of the subset are ceased to be displayed and such as to cause the device to display one or more of the plurality of selectable menu options that do not form part of the subset of the selectable menu options.

A second aspect of the invention provides an apparatus comprising at least one processor and at least one memory including computer program code, the at least one memory and the computer program code configured to, with the at least one processor, cause the apparatus to at least perform: defining a plurality of selectable menu options, causing display of an arrangement of a subset of the selectable menu options; and causing rotation of the arrangement such that one or more of the plurality of selectable menu options forming part of the subset are ceased to be displayed and such as to cause display of one or more of the plurality of selectable menu options that do not form part of the subset of the selectable menu options.

A third aspect of the invention provides an apparatus comprising: means for defining a plurality of selectable menu options; means for causing display of an arrangement of a subset of the selectable menu options; and means for causing rotation of the arrangement such that one or more of the plurality of selectable menu options forming part of the subset are ceased to be displayed and such as to cause display of one or more of the plurality of selectable menu options that do not form part of the subset of the selectable menu options.

A fourth aspect of the invention provides a non-transitory computer-readable storage medium having stored thereon computer-readable code, which, when executed by computing apparatus, causes the computing apparatus to define a plurality of selectable menu options, to cause display of an arrangement of a subset of the selectable menu options and to cause rotation of the arrangement such that one or more of the plurality of selectable menu options forming part of the subset are ceased to be displayed and such as to cause display of one or more of the plurality of selectable menu options that do not form part of the subset of the selectable menu options.

This specification also describes a method of operating a device, the method comprising: causing the device to display a menu having a plurality of nodes, wherein the plurality of nodes comprises a root node and first and second selectable subsidiary nodes, wherein: a first one of the plurality of nodes relates to a service or secondary device, a second one of the plurality of nodes relates either to the device, or to a functionality associated with the service or secondary device corresponding to said first one of the plurality of nodes, and either the first one of the plurality of nodes or the second one of the plurality of nodes comprises the root node; and causing the device to display a status indicator between the first one of the plurality of nodes and the second one of the plurality of nodes, the status indicator providing information about the status of a connection between the device and the service or secondary device associated with the first one of the plurality of nodes.

This method may further comprise receiving a user input comprising a selection of the status indicator or one of the subsidiary nodes, in response to receiving the user input, providing plural connection configuration options and in response to selection of one of the plural connection configuration options, changing the configuration of said connection.

The method may further comprise causing the device to display a navigational aid comprising a marker for each subsidiary node.

The markers may be arranged along an arc.

The first one of the plurality of nodes may be the first subsidiary node and said second one of the plurality of nodes may be the root node. The root node may relate to the device and the second subsidiary node may relate to a service or secondary device which is different to the service or secondary device associated with the first subsidiary node.

The method may further comprise selecting one of said first and second subsidiary nodes and causing the device to display a sub-menu comprising a sub-menu root node and first and second sub-menu subsidiary nodes. The sub-menu root node may relate to the service or secondary device associated with said one of the first and second subsidiary nodes. The sub-menu subsidiary nodes may relate to different functionalities, each functionality being associated with the service or secondary device corresponding to the sub-menu root node.

The method may further comprise selecting one of said first and second sub-menu subsidiary nodes and in response to selecting one of said first and second sub-menu subsidiary nodes, providing plural configuration options relating to the functionality corresponding to said selected one of said first and second sub-menu subsidiary nodes and in response to selection of one of the plural connection configuration options, changing the configuration of said connection.

The method may further comprise causing the device to display a sub-menu navigational aid comprising a marker for each sub-menu subsidiary node and an indicator relating to the parent menu.

The markers for each sub-menu subsidiary node may be arranged along an arc.

The indicator relating to the parent menu may comprise an arc concentric with the arc along which the nodes are arranged.

The method may further comprise causing the device to display an image, the image being selectable for adding a subsidiary node to the menu; receiving a user input comprising a selection of the selectable image; in response to receiving the user input, causing the device to display a menu having a plurality of nodes including the root node, the first subsidiary node, the second subsidiary node and a third subsidiary node, wherein the third subsidiary node relates to a service or secondary device which is different to the service or secondary device associated with the first subsidiary node and to the service or secondary device associated with the second subsidiary node.

The user input may further comprise selecting a service or device from a plurality of different options. The third node may correspond to the selected service or device.

Said first one of the plurality of nodes may be the root node and said second one of the plurality of nodes may be the first subsidiary node. The first and second subsidiary nodes may respectively relate to different functionalities, each functionality being associated with the service or secondary device corresponding to the root node.

The method may further comprise causing the device to display an image, the image being selectable for adding a subsidiary node to the menu; receiving a user input comprising a selection of the selectable image; in response to receiving the user input, causing the device to display a menu having a plurality of nodes including the root node, the first subsidiary node, the second subsidiary node and a third subsidiary node, wherein the third subsidiary node relates to a functionality which is different to the functionality associated with the first subsidiary node and to the functionality associated with the second subsidiary node.

The user input may further comprise selecting a functionality from a plurality of different options, wherein the third node corresponds to the selected functionality.

The method may further comprise monitoring the status of the connections corresponding to each status indicator; determining whether the status of a connection has changed and in response to determining that the status of a connection has changed, updating the corresponding status indicator.

### BRIEF DESCRIPTION OF THE DRAWINGS

Embodiments of the present invention will now be described, by way of example only, with reference to the accompanying drawings, in which:

FIG. 1 shows a mobile terminal according to various aspects of the invention;

FIG. 2 shows some aspects of the hardware and software configuration of the terminal of FIG. 1;

FIG. 3 schematically illustrates data connection with different web services

FIG. 4 shows a menu displayed by the device of FIG. 1;

FIG. 5 shows a sub-menu displayed by the device of FIG. 1;

FIG. 6 shows a status view displayed by the device of FIG. 1;

FIG. 7 shows a settings view displayed by the device of FIG. 1;

FIGS. 8a and 8b show a log view displayed by the device of FIG. 1;

FIG. 9 shows a sub-menu displayed by the device of FIG. 1;

FIG. 10 shows a rotatable arrangement of selectable options displayed by the device of FIG. 1;

FIG. 11 shows the arrangement of FIG. 10 following rotation through 36 degrees;

FIG. 12 shows a login view displayed by the device of FIG. 1;

FIG. 13 shows a view displayed by the device of FIG. 1, showing functionality options;

FIG. 14 shows the menu of FIG. 4 following addition of an additional node;

FIG. 15 shows a sub menu displayed by the device of FIG. 1, the sub menu having a root node;

FIG. 16 shows rotatable list of different functionality options displayed by the device of FIG. 1;

FIG. 17 shows a first time setup view displayed by the device of FIG. 1;

FIG. 18 shows the sub menu of FIG. 15 following addition of a leaf node.;

FIG. 19 shows the sub menu of FIG. 18 following addition of several leaf nodes;

FIG. 20 shows a state diagram illustrating different user interface views;

and navigation options therebetween;

FIG. 21 shows a connection log displayed by the device of FIG. 1;

FIG. 22 shows different status indicators;

FIG. 23 shows animation frames for different status indicators; and

FIG. 24 shows different leaf node arrangements.

### DETAILED DESCRIPTION OF THE EMBODIMENTS

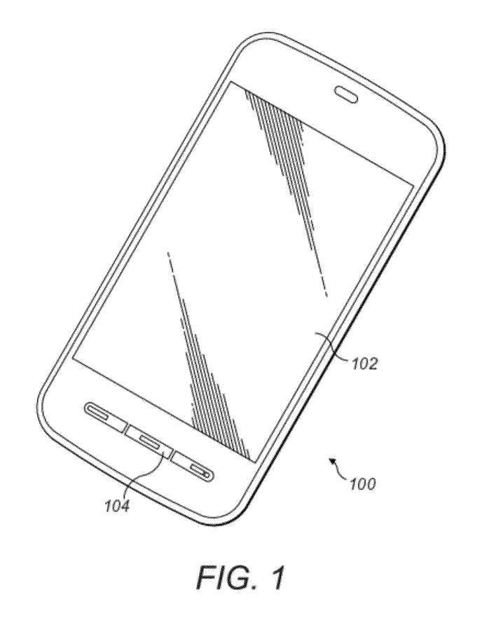

Referring firstly to FIG. 1, a terminal 100 is shown. The terminal 100 embodies aspects of the invention and is not limiting on the scope of the invention. The terminal 100 has a touch sensitive display, or touchscreen 102 for displaying content and for receiving tactile user inputs. The terminal may also comprise one or more physical keys 104 for receiving inputs from a user. The terminal 100 is a mobile computer, mobile phone, PDA, internet tablet, smartphone or other device.

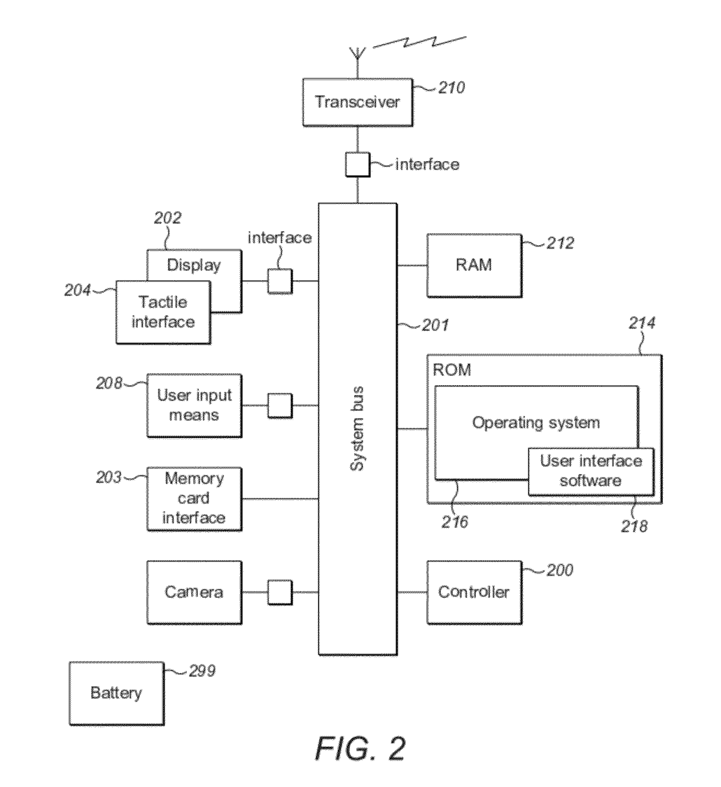

FIG. 2 is a block diagram illustrating some aspects of the hardware and software configuration of the terminal 100. The terminal includes a controller 200 comprising one or more processors. The controller 200 communicates with the other hardware components via a system bus 201. Each hardware component is connected to the system bus 201 either directly or via an interface.

The terminal 100 includes both volatile memory 212 and non-volatile memory 214. Both types of memory are accessed by controller 200 via the system bus 201 and both types are connected directly to the system bus 201. The volatile memory 212 is RAM, DRAM or any other type of volatile memory. The volatile memory 212 is used by the controller 200 for the temporary storage of data, for instance when controlling the operation of another hardware or software component or moving data between components. The non-volatile memory 214 is ROM, flash memory, a hard disk or any other type of non-volatile memory. The non-volatile memory 214 stores computer readable instructions used in operating the terminal 100 as well as storing content and personal data such as images, videos, music and contacts. A file digital file system having a hierarchal folder structure may be employed to organise content and personal data in different folders.

The touch sensitive display 102 comprises a display part 202 and a tactile interface part 204. The controller 200 receives inputs from the tactile interface 204 and controls the display shown on the display part 202. The touch sensitive display 102 is connected to the system bus 201 by an interface. User input means 208 are connected to the system bus 201 via an interface and include one or more physical keys 104 and/or any other input means such as a QWERTY or numeric keypad, microphone or accelerometer. The terminal 100 also has a camera 209 connected to the system bus 201 via an interface. The camera is configured to take digital photographs which can be stored in the memory 214. The terminal 100 also contains a transceiver 210 connected to the system bus 201 via an interface for communicating over a wireless link, such as a GSM, CDMA, UMTS, LTE, WiMax or Wi-Fi link.

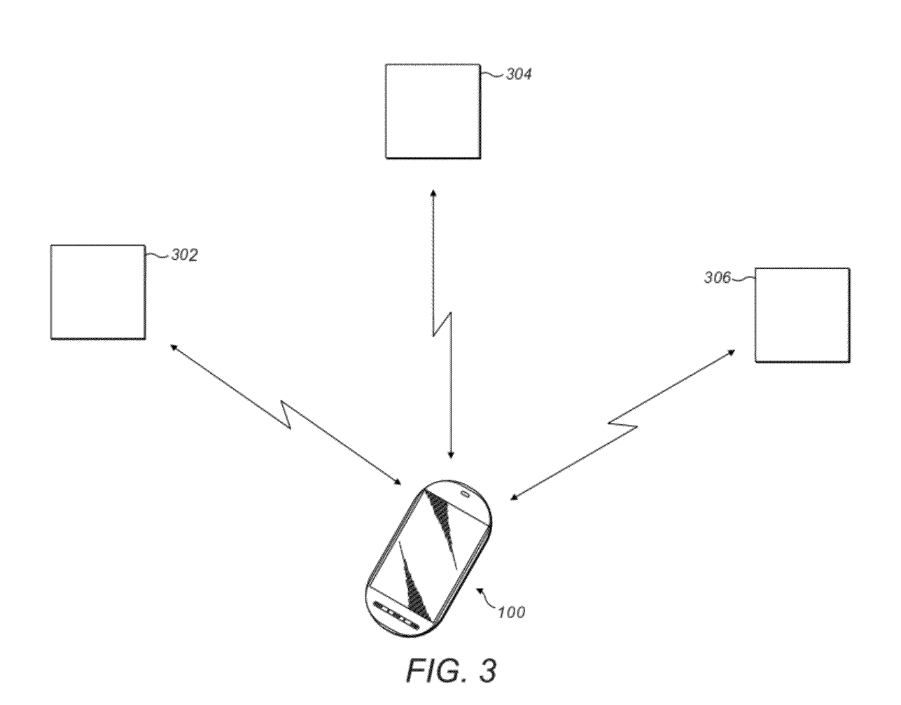

As is schematically illustrated in FIG. 3, the terminal 100 may be configured for data connection with a plurality of different web services 302, 304, 306. Data can be transferred from the terminal 100 to the web services 302, 304, 306 and vice versa via the wireless link.

The web services 302, 304, 306 may be configured to allow upload of data from the terminal 100 to the service for storage or to make the data available to other service users. A user of the mobile terminal 100 may for example upload digital photographs stored on the terminal 100 to the Flickr service 302 to share his photographs with other Flickr users.

The terminal 100 and web services 302, 304, 306 may also be configured to allow download from the services 302, 304, 306 to the terminal 100. For example, a user of the mobile terminal may download digital photographs from the Flickr service 302 for local storage at the terminal 100.

Some web services provide the possibility for synchronisation of content between data stored by the web service and data stored on a mobile terminal 100. For example, the Ovi™ service allows subscribers to synchronise contact and calendar data to keep this data up-to-date both online and on a mobile terminal. Synchronisation comprises transfer of data from the terminal 100 to a service 302, 304, 306 and/or from the service 302, 304, 306 to the terminal 100.

Referring again to FIG. 2, the terminal 100 also includes a memory card interface 203 comprising a memory card slot for receiving a memory card. The memory card interface allows data to be transferred between the terminal 100 and the memory card. The terminal 100 also includes a battery 299 for storing electrical energy.

The controller 200 operates under the control of computer-readable instructions stored in the non-volatile memory 214, which include an operating system and additional software, middleware or firmware modules, and software applications. The operating system 216 is the Maemo operating system, developed by Nokia Corporation. It may alternatively be the Meego operating system, Symbian, or another operating system. As shown, non-volatile memory 214 also includes user interface software 218. The controller 200 may also comprise one or more application specific integrated circuits (ASICs) (not shown).

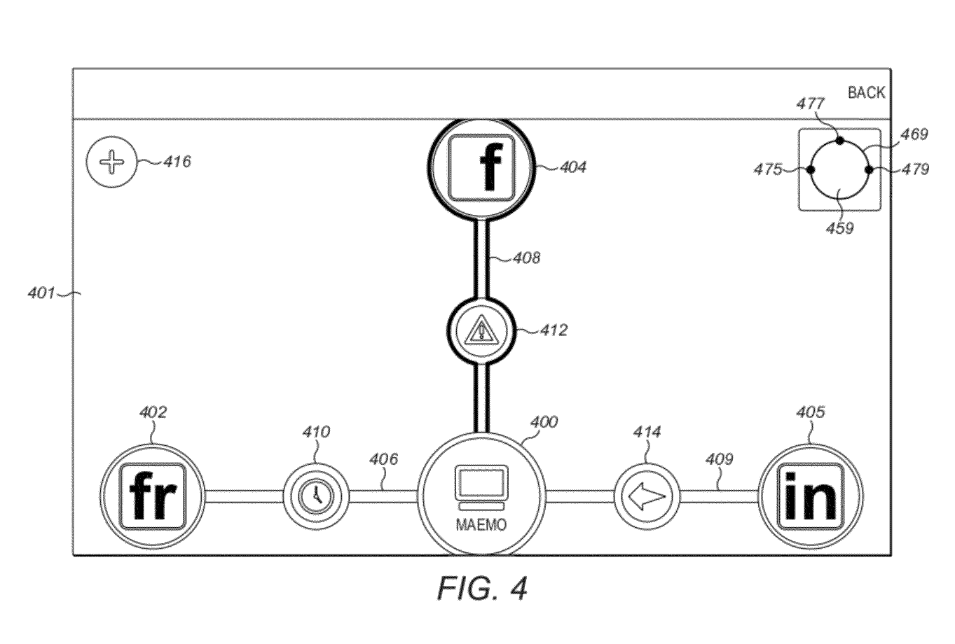

FIGS. 4 to 19 illustrate exemplary operations of the terminal 100 of FIG. 1 according to a first exemplary aspect of the invention. In the operations of FIGS. 4 to 19, the controller 200 performs the stated functions and actions, including controlling the display of content on the display part 202, under the control of user interface software 218. User inputs are detected by the user interface software 218 and are acted upon to control a state of the user interface software 218 and thus the terminal 100. It is the user interface software 218 that generates images for display and that results in some elements of the displayed images being selectable by a user through a user input.

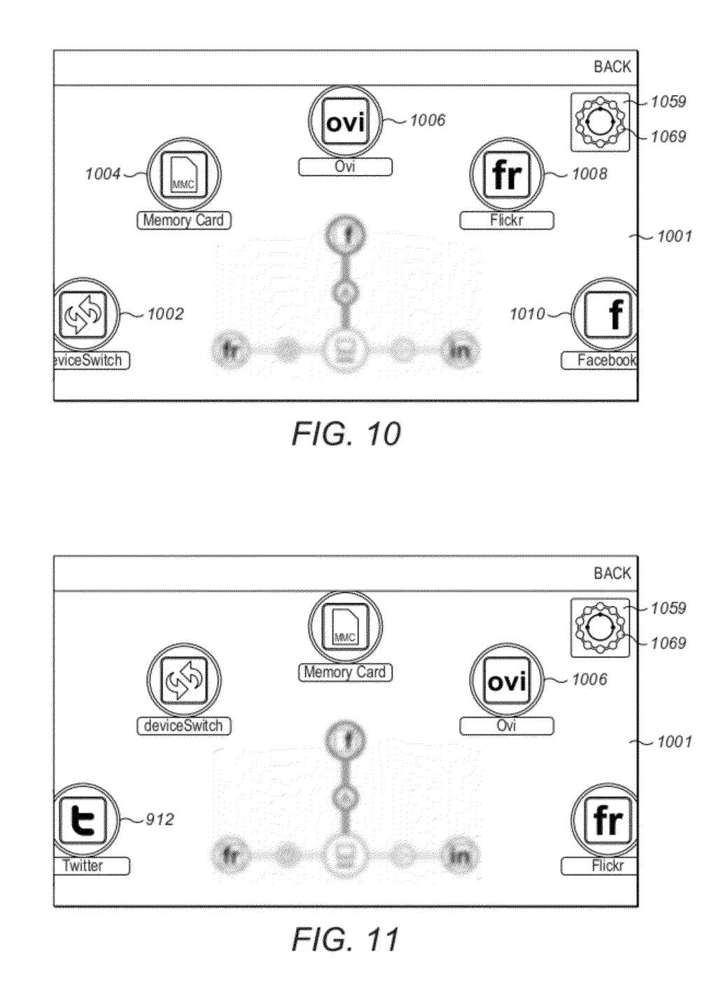

Certain features of aspects of the invention will now be described with reference in particular to FIGS. 10 and 11.

FIG. 10 shows an output of display part 201, in which the terminal 100 is displaying a menu comprising an arrangement 1001 of selectable menu options 1002, 1004, 1006, 1008, 1010. In response to a user input, the terminal 100 is configured to rotate the arrangement, thereby to bring hidden options into view. By way of example, FIG. 11 shows the arrangement of options after a clockwise rotation through one tenth of a full rotation, i.e.: 36 degrees.

A full rotation through 360 degrees brings the arrangement back to its starting position, with the same options displayed. Accordingly, the user has the sense of a virtual ring of evenly spaced options which rotate as a solid body around a central point, where only a sector of the ring is visible on the display 202 at any one time.

The rotatable arrangement of FIGS. 10 and 11 displays a selection of some but not all of the available options concurrently, thereby providing an uncluttered display. This is particularly relevant for mobile devices, where the size of the display screen is limited. The user can intuitively estimate the number of hidden options, since these are the options in the virtual ring which are not displayed on the display part 202.

The menu of FIGS. 10 and 11 may form one of the menus of menu system, for example a hierarchical menu system. An environment in which the menu of FIGS. 10 and 11 is included as a sub-menu will now be described with reference to FIGS. 4 to 19.

FIG. 4 shows an output of display part 202, in which the terminal is displaying a main menu 401 comprising a root node 400, a first leaf node 402, a second leaf node 404 and a third leaf node 405. This output is provided by the device under control of the user interface software 218. The root node 400 comprises an encircled icon of a mobile computer which denotes the terminal 100. The leaf nodes 402, 404, 405 are termed leaf nodes because they are the terminal nodes in the display, although it will be seen from the description below that these nodes can in other displays have nodes depending therefrom. These leaf nodes 402, 404, 405 may be termed subsidiary nodes since they are subsidiary to the root node 400 but may not be the absolute end nodes in the menu 401.

The leaf nodes 402, 404, 405 of FIG. 4 relate to services 302, 304, 306 and therefore can be referred to as service nodes. However, it will be appreciated that the menu 401 may include leaf nodes which denote entities other than services. For example a leaf node may denote a data source such as a memory card or other secondary device. As will be more fully understood from the examples below, the user may navigate the menu 401 to change configuration options relating to the entities denoted by the leaf nodes.

As shown in FIG. 4, the first leaf node 402 comprises an encircled icon denoting the first web service 302. The second leaf node 404 comprises an encircled icon denoting the second web service 304 and the third leaf node 405 comprises an encircled icon denoting the third web service 306. Each web service may for example be one of Ovi, Flickr, Facebook, LinkedIn, YouTube, FileVault, DropBox or Twitter.

Referring to FIG. 4, the leaf nodes 402, 404, 405 are radially equidistant from the central root node 400. Graphical links in the form of first, second and third radial graphical connections 406, 408, 409 are shown between the root node 400 and each leaf node 402, 404, 405. These indicate that the terminal 100 may connect to the first, second and third web services 302, 304, 306. The menu is thus arranged in an intuitive way which is analogous to the schematic or “mental picture” shown in FIG. 2.

The first graphical connection 406 comprises a first status indicator 410 between the root node 400 and the first leaf node 402. The first status indicator 410 indicates the status of the connection between the terminal 100 (denoted by the root node 400) and the first web service 302 (denoted by the first leaf node 402). The status indicator 410 comprises an encircled image of a clock, which indicates that the terminal 100 is scheduled to synchronise data with the first web service 302 at a future time.

The second graphical connection 408 comprises a second status indicator 412 which indicates the status of the connection between the terminal 100 and the second web service 304. The status indicator 412 comprises an encircled warning sign, which indicates that there is an error in the connection between the terminal 100 and the second web service 304.

The third graphical connection 409 comprises a third status indicator 414 which indicates the status of the connection between the terminal 100 and the third web service 306. The status indicator 414 comprises an encircled image of an arrow, which points towards the root node. This indicates that data is being downloaded from the third web service 306 to the terminal 100.

The status indicators 410, 412, 414 allow the user to monitor the status of active and inactive data connections with the terminal 100. The controller 200, under instruction of the operating system 216, is configured to periodically monitor the status of each data connection and update the status indicators 410, 412, 414 accordingly. Therefore, the status indicators 410, 412, 414 are dynamic status indicators.

The menu 200 thus provides a holistic, up-to-date view of the status of all active connections and also of any connection errors. In this way, the user can obtain connection information with minimal interaction between the user and the terminal 100.

It will be appreciated that other status indicators may be displayed, depending on the status of the relevant connection. Exemplary status indicators are illustrated in FIG. 22, which show status indicators for download 2202, upload 2204, synchronisation 2206, backup 2208, disabled 2210, pending 2212, error 2214 and paused 2216 connection states.

The leaf nodes 402, 404 and the status indicators 410, 412 of the menu 401 of FIG. 4 are user-selectable to allow connection options to be configured. A user may select the leaf nodes 402, 404 or status indicators 410, 412 by touching a corresponding area of the touch sensitive display 102.

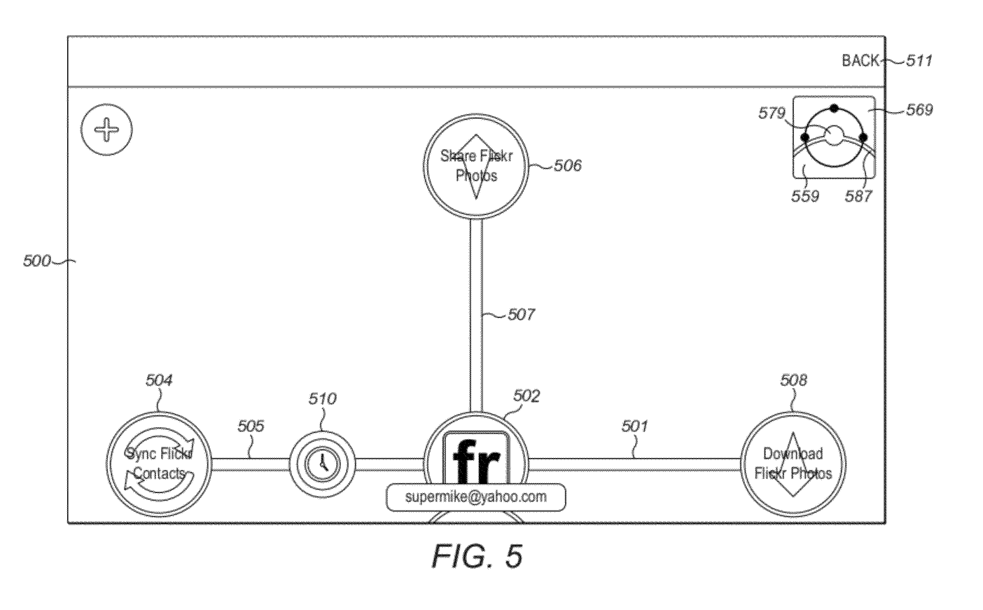

In response to user selection of the first leaf node 402, the controller causes a sub-menu 500 to be displayed on the display part 202. The sub-menu 500 is shown in FIG. 5. As shown, sub-menu 500 includes a root node 502 which is a service node comprising an encircled icon representing the first web service 302.

The sub-menu 500 also includes first, second and third sub-menu leaf nodes 504, 506, 508 graphically connected to the root node 502. As shown, each sub-menu leaf node 504, 506, 508 comprises encircled text identifying different features/functionalities associated with the first web service 302. The functionalities represented by the sub-menu leaf nodes 504, 506, 508 are respectively: synchronisation of contact data stored on the first web service with contact data stored on the device (“Sync Flickr Contacts”), upload of photograph data from the device to the first web service thereby to share photos with other users of the first web service (“Share Flickr Photos”), and download of photograph data from the first web service onto the device (“Download Flickr Photos”). The sub-menu leaf nodes can be referred to as functional nodes, since they relate to different functionalities associated with the first web service 302. It will be appreciated that the sub-menu could include further nodes relating to further functionalities, for example scheduled backup of photos stored on the terminal 100.

The sub-menu also includes a “back” button 511, which allows the user to navigate back to the menu of FIG. 4. A “back” button is shown in each of FIGS. 5, 6, 7, 8a, 8b and 9-19. Generally, the back button 511 allows navigation back to the previously displayed view. For example, where the sub-menu 500 is reached by selecting a leaf node from the menu 401, selecting the “back” button 511 returns the user to the menu 401. It will be appreciated that in some implementations the back button 511 always brings the user back to the previously determined view in this way. However, the user interface may be implemented so that, in some cases, selection of the back button 511 brings the user “back” to a predetermined view other than the previously displayed view. For example, as will be described in more detail below, the back button 511 of FIG. 13 always brings the user to the root menu 401, even where the immediately preceding view is not the root menu 401.

Optionally, selection of the sub-menu root node 502 may also return the user to the root menu 400. In an alternative implementation, selection of the sub-menu root node 502 causes display of a connection activity log for the web service 302, including for example synchronisation and download events.

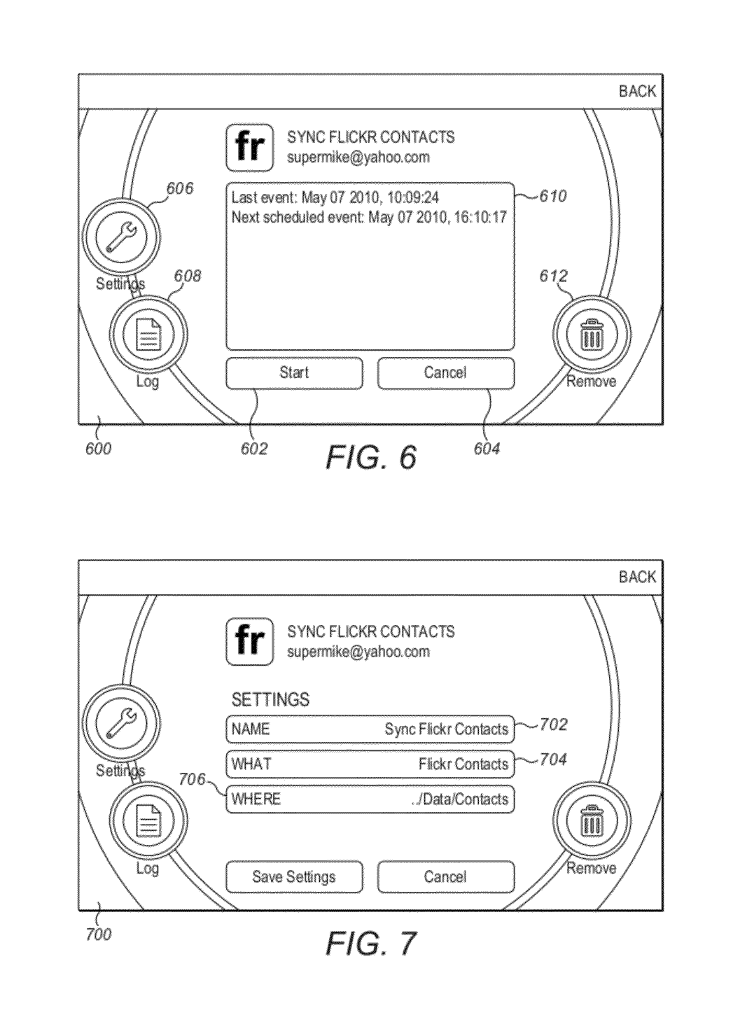

The first sub-menu leaf node 504 is selectable to allow configuration of the contact synchronisation functionality. In response to user selection of the first sub-menu leaf node 504, the controller causes a status view 600 to be displayed. As shown in FIG. 6, status view 600 comprises status information and configuration options relating to contact synchronisation. As shown, the view 600 provides information regarding the last synchronisation event and the next scheduled synchronisation event. A user may start the synchronisation immediately by selecting the “start” button 602 or may cancel synchronisation by selecting the “cancel” button 604. The user may also adjust the settings of the synchronisation functionality by clicking on the “settings” button 606. A log of synchronisation events may be viewed by selecting the “log” button 608. The view 600 also shows the username or unique identifier 610 of the user who is presently logged in to the web service 302. The view 600 also shows a “remove” button 612. If the “remove” button is selected, the first sub-menu leaf node 502 will be removed from the sub-menu 500 and will not be visible when the user navigates back to sub-menu 500. Removed nodes may be added again when required using the “+” button. The procedure for adding nodes will be described in more detail below.

FIG. 7 shows a settings view 700 which is displayed on the display part 202 when the “settings” button 606 is selected. As shown, the settings view 700 lists a “name” field 702, a “what” field 704, a “where” field 706 and a “how” field 708. It will be appreciated that different fields may be displayed depending on the functionality selected from the sub-menu 500.

The “name” field 702 shown in FIG. 7 indicates the text which is displayed in the first sub-menu leaf node 504 of sub-menu 500. A user may change the text which is displayed by editing the “name” field 702 using the tactile interface 208 or user input means 208.

The “what” field 704 indicates that contact data is synchronised. This field may be user-editable to allow different data to be synchronised between the web service 302 and the terminal 100.

The “where” field 706 indicates the folder in the file system of the terminal 100 in which contact data is to be stored. A user may choose for the contact data to be stored in a different folder by selecting the “where” field and choosing a folder from a predetermined list.

Other fields may be displayed, depending on the selected functionality. For example, a “how” field may also be displayed to indicate how the synchronisation is performed. Possible options for the “how” field include “manual”, “disabled”, “scheduled” and “auto”.

The view 700 also includes a “save settings” button which allows a user to save any changes to the setting, and a “cancel” button to allow a user to cancel any changes made.

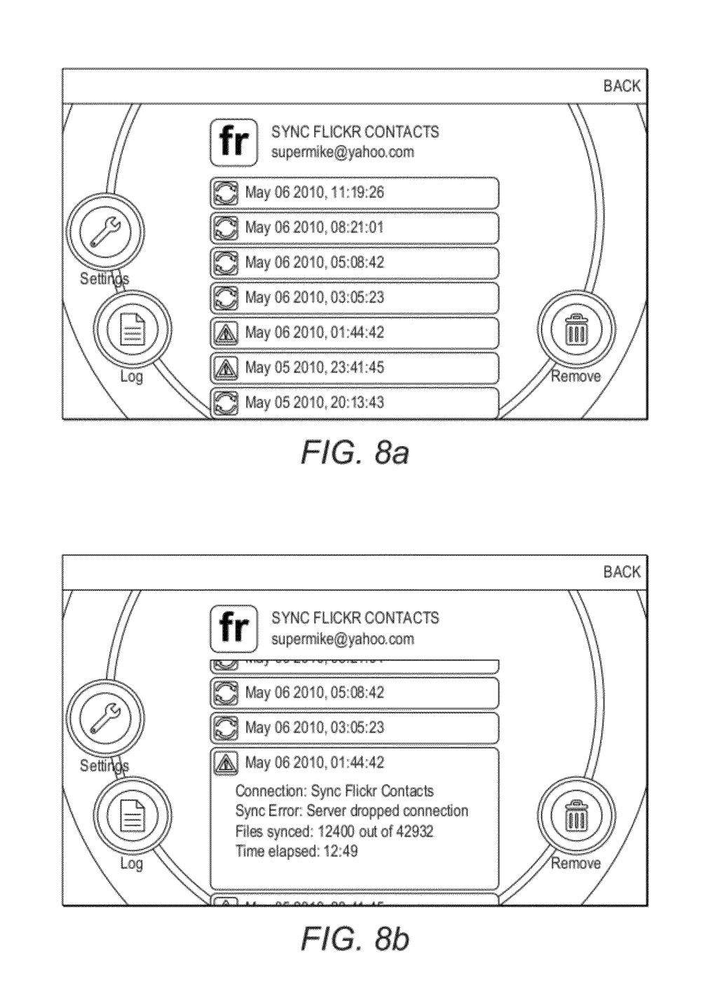

FIG. 8a shows a log view 800 which can be reached by selecting the “log” button 608 of view 600 of FIG. 6. The log view 800 shows a list of contact synchronisation events for web service 302, along with the time of each event. As shown, icons are shown to summarise the event. For example, a warning/failure icon is displayed where an error occurred in relation to a particular synchronisation event.

A user may select one of the listed events to display further information relating to the event. FIG. 8b shows an example of further information for a warning/failure. As shown, the reason for the failure is shown to the user along with synchronisation details including time elapsed, the connection type and the number of files synched. Optionally, in the case of a successful synchronisation, information relating to the data transferred may be displayed.

It will be appreciated that other log views 800 for other functionalities may be reached from other status views 600 for other functionalities selected from the sub-menu 500, with upload/download/synchronisation events illustrated by corresponding icons.

Returning again to FIG. 5, graphical links 501, 505, 507 are displayed between the root service node 502 and the functional nodes 504, 506 and 508 to indicate that the functional nodes relate to the first web service 302. The graphical link 505 between sub-menu root node 502 and the first sub-menu leaf node 504 has a selectable sub-menu status indicator 510. The sub-menu status indicator 510 is identical to the first status indicator 410 of FIG. 4 and comprises an encircled image of a clock. The sub-menu status indicator 510 indicates the status of the synchronisation function, in this case indicating that the terminal 100 is scheduled to synchronise data with the first web service 302 (denoted by the sub-menu root node 502) at a future time.

As described above, the view 600 of FIG. 6 can be reached by selection of the leaf node 504. However, this view 600 can also be reached by selection of the sub-menu status indicator 510, or alternatively by selection of the first status indicator 410 of FIG. 4.

The “Share Flickr Photos” leaf node 506 and the “Download Flickr Photos” leaf node 508 are also selectable in order to adjust configuration settings. When the “Share Flickr Photos” node 506 is selected for example, a status view 600 is displayed which is similar to the view of FIG. 6, except that information relating to the last share and the number of files shared is displayed instead of information relating to the last or next scheduled event. The user may initiate the share photos function by selecting a “start” button, view a log by selecting a “log” button or configured settings for the share photos function by selecting a “settings” button, in the same way as described above in relation to the “Share Flickr Contacts” node. Selecting the “settings” button brings up a view similar to FIG. 7, which allows configuration of various settings for the “Share Flickr Photos” functionality. For example, the user may adjust the name of the local folder containing the photos to be shared, whether the shared photos should be made public on the Flickr website, or whether the uploaded content should be restricted to particular users or user groups.

Similarly, a user may configure the “download Flickr photos” functionality by selecting the corresponding functional node 508. In response, a status view for the “download Flickr photos” is displayed. This view may display information relating to the last download and the number of files downloaded.

It will be appreciated that selection of one of the other service nodes 404, 405 of FIG. 4 causes a different sub-menu to be displayed, the sub-menu having a root node comprising the corresponding service node and a plurality of different functional nodes graphically connected to the root node, each functional node relating to a different functionality. The functional nodes thus displayed may be selected by a user to configure corresponding functions of the service.

It will be appreciated that different status views 600 are displayed depending on the selected functional node. Different functionalities may have different configuration options which may be configured via their corresponding status views 600. For example, synchronisations may be configured such that either the client or server takes priority when syncing, thereby to implement client/server conflict resolution. Further, a user may optionally configure downloads by for example specifying details such as username data or by specifying images which are to be downloaded to the terminal 100, for example by specifying image tags.

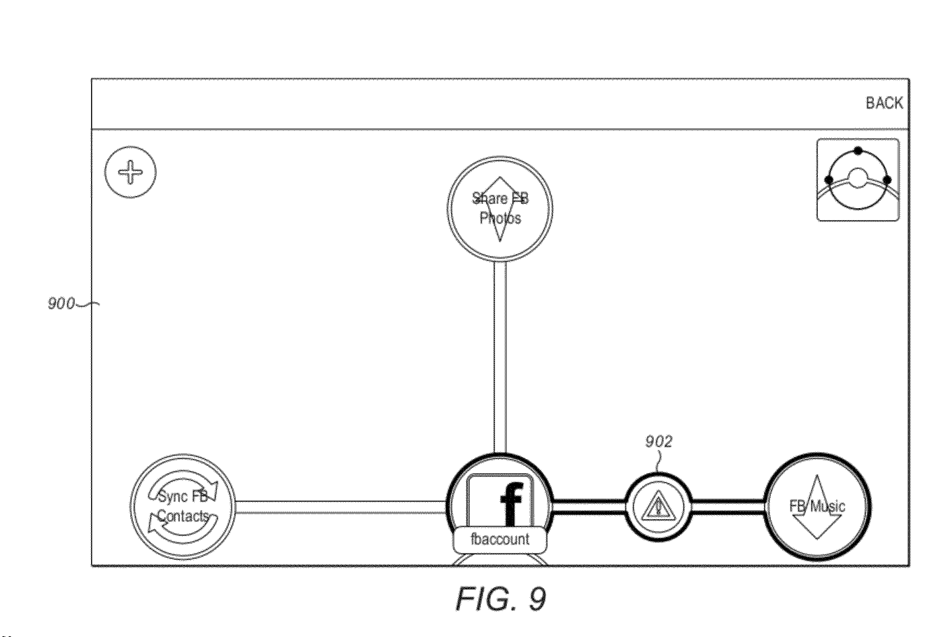

FIG. 9 shows the sub-menu 900 which is displayed when the service node 404 of FIG. 4 is selected. As shown, the sub-menu 900 has a status indicator 902 which indicates that there is a connection error relating to transfer of data between the terminal 100 and the second web service 306 and that this error relates to the “Facebook music” functionality.

Returning again to FIG. 4, as shown an encircled “+” icon 416 is displayed in the top left corner of the menu. This icon is user-selectable and allows a user to add further leaf nodes to the menu. The procedure for adding further leaf nodes to the menu of FIG. 4 will now be described with reference to FIGS. 10-14. This procedure allows a straightforward and convenient way for a user to set up multiple connections with the terminal 100.

In response to user selection of the “+” icon 416, the controller 200 causes the sub-menu of FIG. 10 to be displayed on the display part 202. As shown, the sub-menu of FIG. 10 comprises an arrangement 1001 of selectable menu options 1002, 1004, 1006, 1008, 1010. The options 1002, 1004, 1006, 1008, 1010 are evenly spaced and arranged along an arc, which may be circular. As shown, an out of focus or blurred image of the menu of FIG. 4 is displayed within the arc of icons. It will be appreciated that the arc itself need not necessarily be displayed. Each option comprises an encircled icon which when it is selected may be added as a leaf node to the menu of FIG. 4.

In response to a user input via the touchscreen 102 or the keys 104, the controller 200 is configured to cause the arrangement of options to rotate either clockwise or anticlockwise on the display part 202. Rotation occurs around a point that is central to the arc. The user input may comprise a repeated pressing of one of the keys 104, or alternatively a left or right sweeping movement across the touchscreen 102, for example in a straight line or in a clockwise or anticlockwise arc.

FIG. 11 shows the arrangement of options after a clockwise rotation through one tenth of a full rotation, i.e. 36 degrees. As shown, one of the previously displayed options 1010 has become hidden from view, while a previously hidden option 912 has been brought into view. Further rotation brings further options into view. It will be appreciated that the arrangement may be rotated anticlockwise as well as clockwise.

A full rotation through 360 degrees brings the arrangement back to its starting position, with the same options displayed. Accordingly, the user has the sense of a virtual ring of evenly spaced options which rotate as a solid body around a central point, where only a sector of the ring is visible on the display 202 at any one time.

The rotatable arrangement of FIGS. 10 and 11 displays a selection of some but not all of the available options concurrently, thereby providing an uncluttered display. This is particularly relevant for mobile devices, where the size of the display screen is limited. The user can intuitively estimate the number of hidden options, since these are the options in the virtual ring which are not displayed on the display part 202.

Selection of one of the options 1002, 1004, 1006, 1008, 1010 causes the corresponding icon to be added as a leaf node to the menu of FIG. 4. As shown in FIGS. 9 and 10 possible options are to include a service node for the “Ovi” service 1006 or the “Twitter” service 912.

A further option is to include a leaf node relating to a secondary device such as a memory card. Configuration options relating to data transfer between the terminal 100 and a secondary device such as a memory card may be configured in a similar manner as for services, i.e.: in the manner described above with reference to FIGS. 6 and 7.

The rotatable arrangement of FIG. 10 also includes an option to add a “device switch” node to the menu of FIG. 4. “Device switch” is a local service which allows selectable data transfer between the terminal 100 and other external devices, for example via a Bluetooth link. Configuration options relating to the “device switch” connection may be configured in a similar manner as for services as described hereinabove.

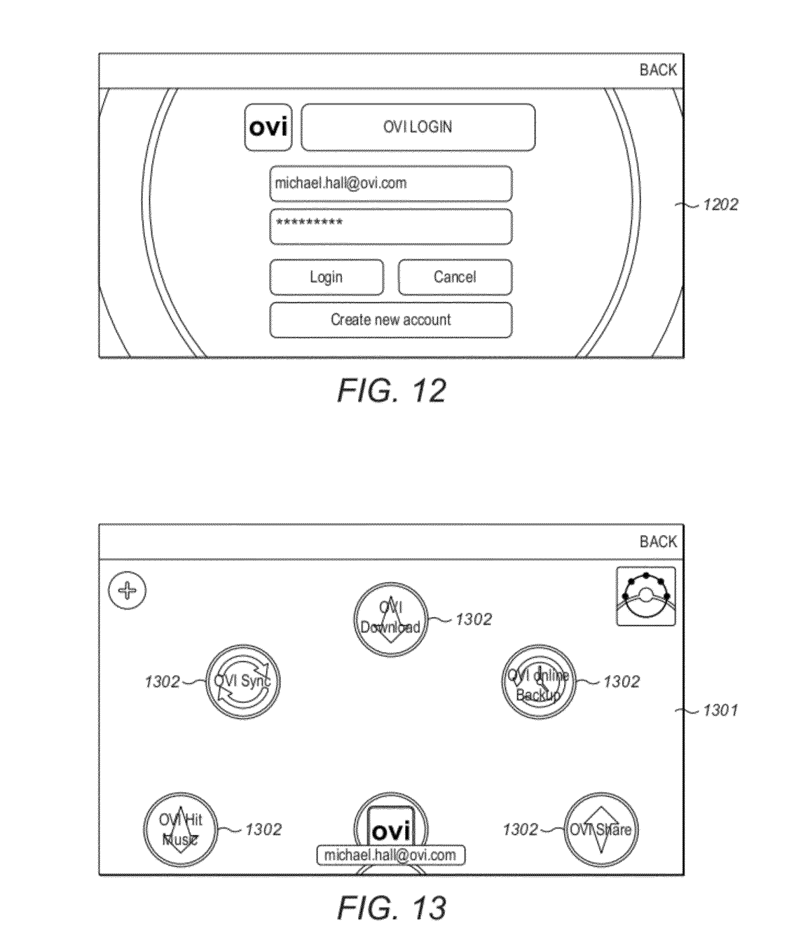

Addition of a leaf node for the “Ovi” service will now be described with reference to FIGS. 10-14. When the “Ovi” option 1006 is selected from the rotatable arrangement of FIG. 10 or 11, a login screen 1202 is displayed on the display part 202, which is shown in FIG. 12. A user enters their username and password and presses the login button, causing the terminal 100 to log in to the Ovi™ service. Alternatively, the user may select “cancel” to return to the options menu of FIG. 11. Further alternatively, the user may select the “create new account” button. Selection of this option executes a web browser stored on the terminal 100, which opens a web page to allow service-specific account creation.

Once the user has been logged in, the terminal 100 displays the view 1301 shown in FIG. 13. This view shows a node 1302 for each of the functionalities of the Ovi service which can be added as a sub-menu functional nodes for the Ovi service, as is described in more detail below. The nodes of FIG. 13 are user selectable. Selection of one of the nodes causes the terminal 100 to display a configuration screen for the selected functionality, similar to the screen of FIG. 6 but with different configuration options for the selected functionality.

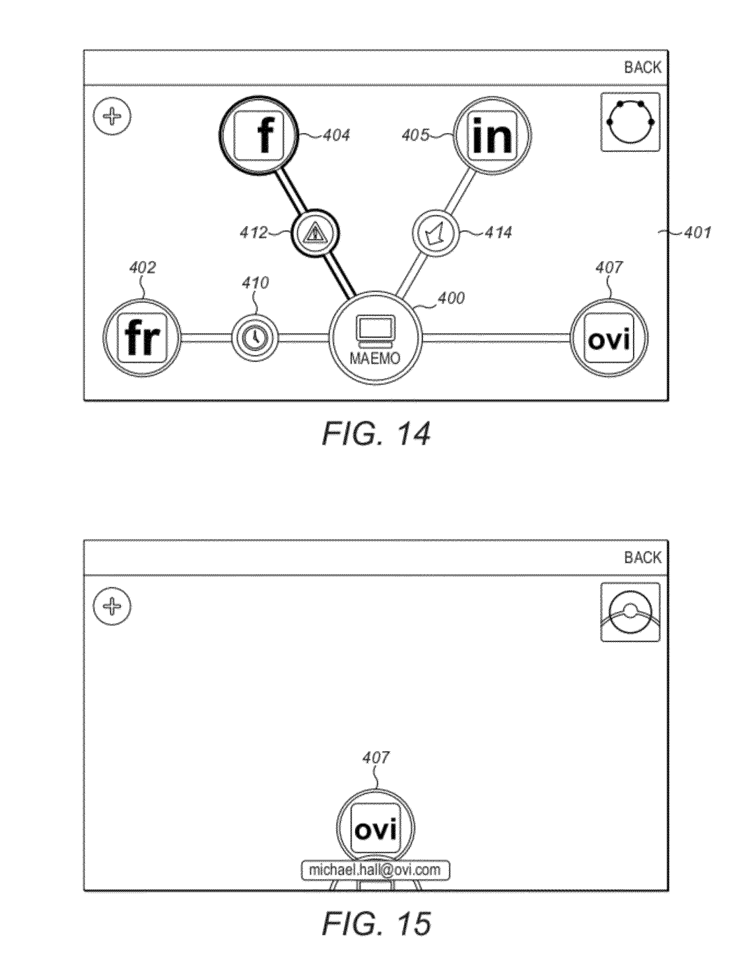

The user can navigate from the view of FIG. 13 by selecting one of the nodes 1302 to configure a selected functionality and initiate a connection with Ovi or by clicking the “back” button, which in this particular case is configured to return the user to the root menu 401. In either case, when the user is returned to the menu 401, an additional service node 407 is displayed for the Ovi service, as shown in FIG. 14.

Selection of the “Ovi” service node from FIG. 14 causes the terminal to display a sub-menu for the “Ovi” node, as shown in FIG. 15. No functional nodes have yet been added and therefore only a root node is shown in FIG. 15.

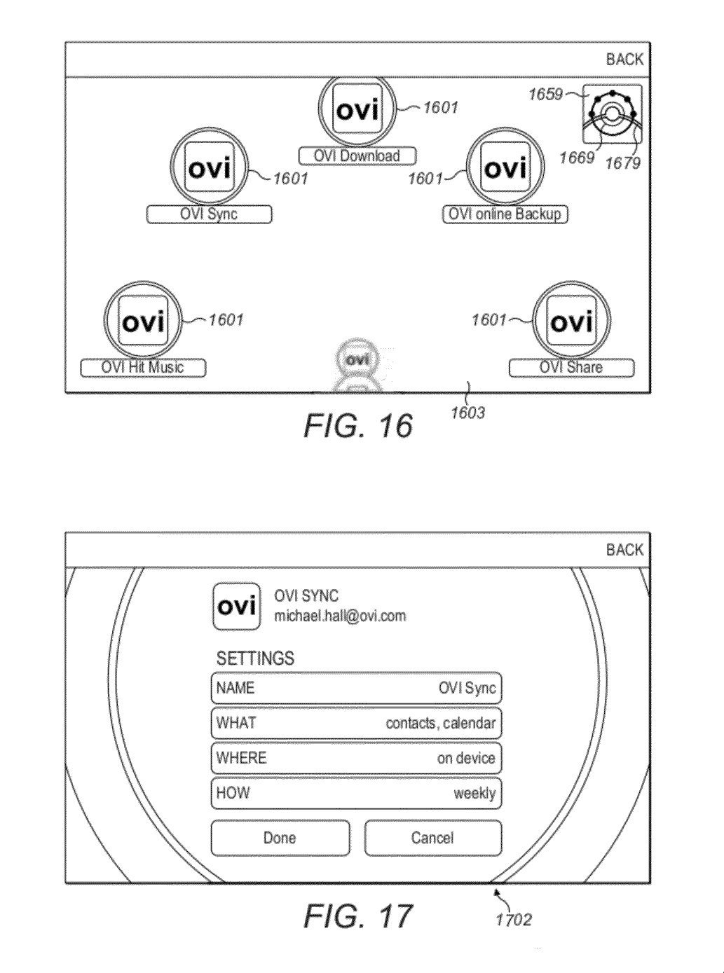

A user may add functional nodes to the sub-menu of FIG. 15 in a similar manner to the manner described above in relation to the addition of service or secondary device nodes to the menu of FIG. 4. That is, the user may add a functional node by selecting the “+” icon and choosing a functional node to be added from a rotatable arrangement 1603 of options 1601, shown in FIG. 16.

Selection of the “sync” option, causes a first time setup view 1702, shown in FIG. 17, to be displayed, thereby providing the user with the option to configure settings for the newly added synchronisation functionality, including configuring what content to synchronise (e.g.: contacts, calendar), and how often to perform the synchronisation. The user then selects the “done” button. In response, the terminal displays a status view 600 which is similar to the view of FIG. 6, which displays status information regarding the Ovi synchronisation functionality, including information regarding the time elapsed, the time remaining, the number of files transferred and a progress bar and which provides options for further configuration of the Ovi functionality.

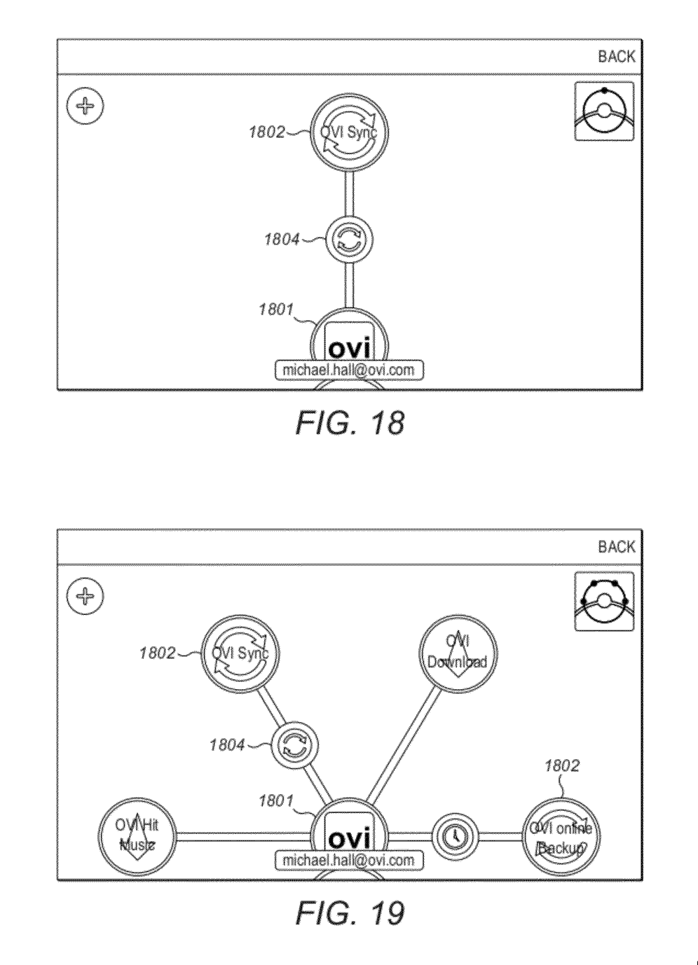

The user may then select “back”, thereby causing the terminal 100 to display the sub-menu of FIG. 18, but with an additional functional node 1802 for the synchronisation functionality, as shown in FIG. 18. Referring to FIG. 18, a status indicator 1804 is shown between the root Ovi service node 1801 and the functional node 1802. Status indicator 1804 shows two curved arrows, indicating that the terminal 100 is presently synchronising with the Ovi service.

It will be appreciated that other functional nodes can be added to the Ovi service sub-menu in a similar manner. FIG. 19 shows the sub-menu after the addition of several further functional nodes. As shown the sub-menu includes a “Ovi online backup” node 1806. The status indicator between the Ovi service node and the “Ovi online backup” node indicates that a scheduled backup to the Ovi service has been set up.

The views of FIGS. 4, 5, 9, 10, 11, 14, 15, 16, 18 each include a navigational indicator in the top right corner to indicate the present level of navigation within the menu hierarchy. In menu 401, the navigational indicator 459 comprises a single highlighted ring 469 having an individual circular marker 475, 477, 479 for each leaf node 402, 404, 405. The navigational indicator 459 thus indicates to the user that the menu 401 is a root menu.

In sub-menu 500, the navigational indicator 559 comprises a highlighted ring 569 having an individual marker for each leaf nodes 504, 506, 508. The highlighted ring 569 is centred on a circular marker 579 representing the corresponding service node 502, 402. The circular maker 579 is shown on a circular arc 587 representing a part of the ring 469 of the navigational indicator 459 of the root menu 401. Thus, it is immediately and intuitively clear to a user glancing at the navigational indicator 559 that the menu 500 is a sub-menu of root menu 401 and that the menu 401 is “below” menu 500 and can be reached by selecting the “back” button.

In the options menu of FIG. 10, the navigational indicator 1059 comprises a highlighted ring 1069 including circular markers for each available option, including hidden options. Thus, the user can immediately see the total number of options and hidden options by glancing at the indicator 1059. The navigational indicator 1059 also shows the ring 469 of menu 401 inside the highlighted ring 1069, indicating that the menu 401 is “below” the options menu of FIG. 10 and can be reached by selecting the “back” button.

Similarly, in the case of the options menu exemplified in FIG. 16, the navigational indicator 1659 comprises a highlighted ring including circular markers for each available option. The navigational indicator 1659 shows two inner rings 1669, 1679 representing menus 501 and 401 respectively indicating that the menus 401 and 501 are “below” the options menu of FIG. 16 and can be reached by selecting the “back” button.

In this way, the navigational aid provides information regarding the level of navigation and regarding the possibility for navigating to other “lower” menus by selecting the “back” button.

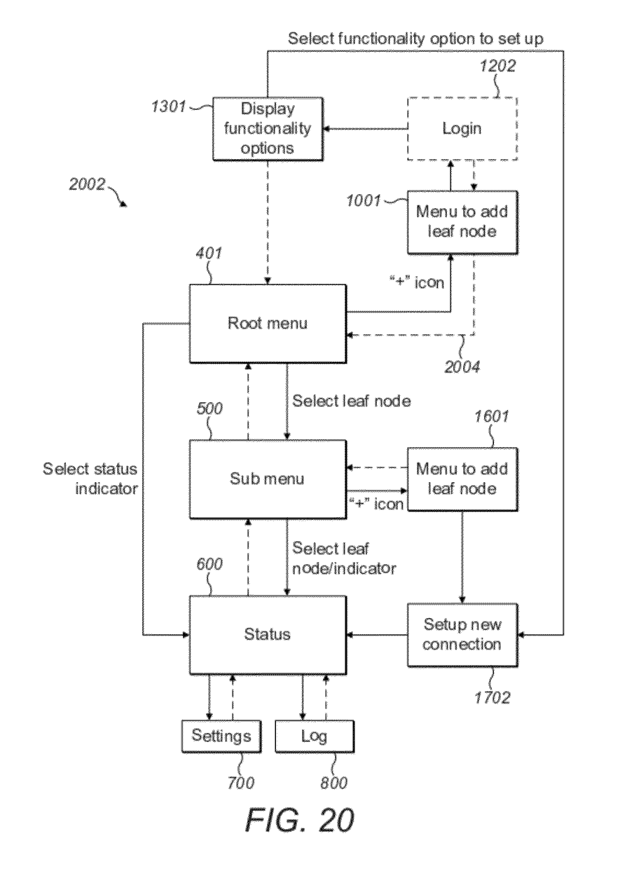

FIG. 20 shows a state diagram 2002 illustrating different user interface views and navigation options therebetween. Like reference signs are used to illustrate the correspondence between the blocks of diagram 2002 and the views of FIGS. 4-19. In the diagram 2002, lines are used to show navigation options from one view to another. Dotted lines 2004 are used to illustrate navigation using the “back” button.

As shown, starting from the root menu 401, a user may select a leaf node and navigate to the sub-menu 500. Alternatively, the user may select a status indicator and navigate to the status menu 600 for the functionality corresponding to the status indicator. Alternatively, the user may select the “+” icon 416 to reach menu 1001 and then follow the procedure described above with reference to FIGS. 10-14 to add an additional leaf node. As described above, the procedure for adding a leaf node comprises entering login information via login view 1202, after which functionality options associated with the selected device/service are displayed in view 1301. From the view 1301, the user may either select a functionality for configuration via “setup new connection” view 1702, or alternatively select the “back” button to return to the root menu 401.

As shown in FIG. 20, starting from the sub-menu 500, a user may select either a leaf node or status indicator and navigate to the status menu 600 for the corresponding functionality. From the status menu 600, the user may navigate to settings view 700 and log view 800. The user may also add leaf nodes to the sub menu 500 by following the procedure described above with reference to FIGS. 16 and 17.

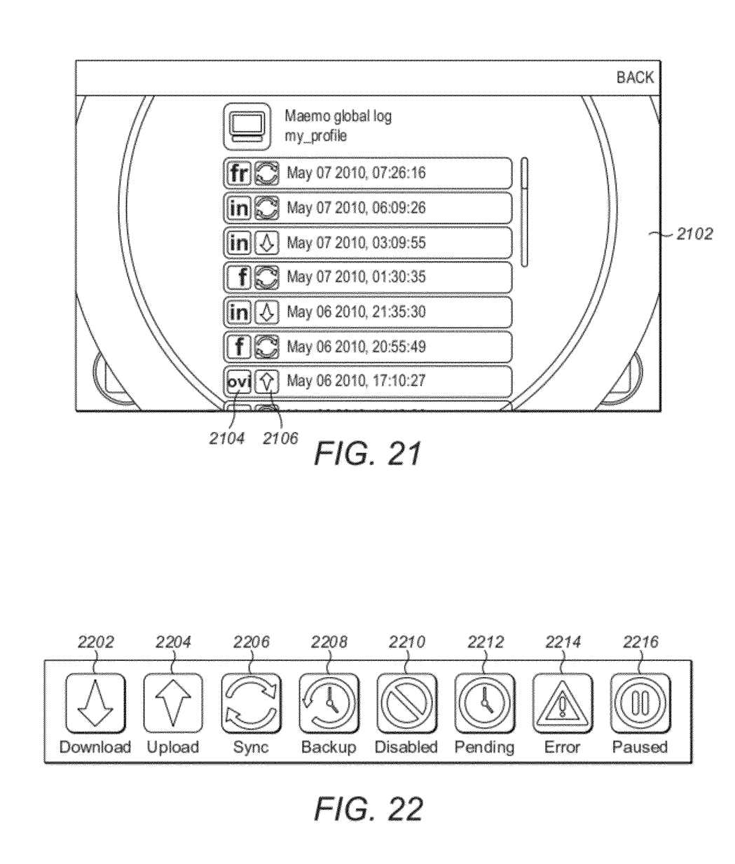

FIG. 21 shows a device connection log 2102, which can be reached by selecting the root node 400 of FIG. 4. The device connection log 2102 shows a history of device connection events. The log 2102 shows icons 2104 representing devices or services to which a connection was made together with the time of each connection. A status indicator 2106 is also shown to indicate the type of connection event. Optionally, log views relating to particular services, secondary devices or functionalities may be accessed from the connection log 2102. For example, the log view 800 of FIG. 8a may be reached from the main log view 2102.

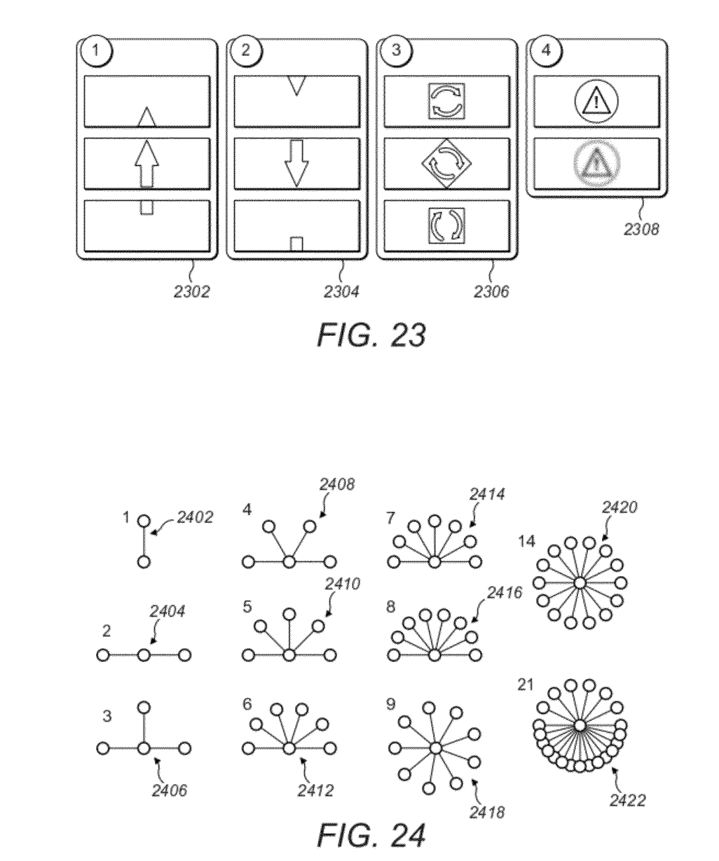

The status indicators shown in the menu 401 and the sub-menu 500 may be animated so as to provide an informative visual effect to the user. FIG. 23 shows different animation frames 2302, 2304, 2306 and 2308 for the upload 2204, download 2202, synchronisation 2206 and error 2214 status indicators. As shown, the upload status indicator 2204 has a three-frame animation 2302 in which an upwardly directed arrow moves from top to bottom. The download status indicator 2202 has a three-frame animation 2304 in which a downwardly directed arrow moves from top to bottom. The synchronisation status indicator 2206 has a three frame animation 2306 in which the arrows move in a circular path. The error status indicator 2214 has a two frame animation 2308 in which a warning sign is shown fading in and out. Other visual effects may also be provided, for example visual effects may be used in transitions between different views.

It will be appreciated that the root and leaf nodes of the root menu 401 and sub-menu 500 could be arranged in a variety of different ways. FIG. 24 shows different possible arrangements 2402, 2404, 2406, 2408, 2410, 2412, 2414, 2416, 2418, 2420, 2422 for different numbers of node images. As shown, node images may be evenly spaced around a semicircular arc, as shown in arrangements 2404, 2406, 2408, 2410, 2412, 2414, 2416. Alternatively, node images may be evenly spaced around a full circle, as shown in arrangements 2418, 2420. Alternatively, node images may be evenly spaced around an upper semicircular arc with a first angular spacing, and evenly spaced around a lower semicircular arc with a second angular spacing, as shown in arrangement 2422. It will be appreciated that the arc itself, or the full circle as the case may be, need not necessarily be displayed.

Although a menu hierarchy involving a node-based root menu 401 and a single node-based sub-menu 500 has been described above, alternatively there may be multiple hierarchical layers of node-based sub-menus. For example, instead of displaying a status view 600 when a subsidiary node 504, 506, 508 is selected, a further node-based sub-menu may alternatively be displayed having a root node corresponding to the selected subsidiary node 504, 506, 508 and a plurality of leaf nodes, each providing access to a status view 600 either directly or via further hierarchical levels. It will be appreciated that the number of hierarchical levels may be different for different root menu leaf nodes, depending on the corresponding service or subsidiary device. For example, some services may not require a sub-menu, in which case a status view 600 may be displayed when the corresponding leaf node 401, 402, 404 is selected, instead of displaying a sub-menu 500.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

We claim:

1. A method of operating a device, comprising:
defining a plurality of selectable menu options;
causing the device to display an arrangement of a subset of the selectable menu options; and
causing the device to rotate the arrangement such that one or more of the plurality of selectable menu options forming part of the subset are ceased to be displayed and such as to cause the device to display one or more of the plurality of selectable menu options that do not form part of the subset of the selectable menu options.

2. A method as claimed in claim 1, further comprising:
evenly spacing displayed selectable menu options.

3. A method as claimed in claim 1, further comprising:
causing the device to display an indicator, the indicator indicating the number of selectable menu options that are not displayed.

4. A method as claimed in claim 3, wherein the selectable menu options are arranged along an arc and wherein the indicator comprises a plurality of markers arranged in a ring, the indicator including one marker for each user-selectable option and for each hidden option.

5. A method as claimed in claim 4, wherein the markers are evenly spaced around the ring.

6. A method as claimed in -claim 1, further comprising:
selecting an option; and
in response to selection of the option, including a selectable image corresponding to the selected option in a menu.

7. An apparatus comprising:
at least one processor; and
at least one memory including computer program code,
the at least one memory and the computer program code configured to, with the at least one processor, cause the apparatus to at least perform:
define a plurality of selectable menu options;
cause display of an arrangement of a subset of the selectable menu options; and
cause rotation of the arrangement such that one or more of the plurality of selectable menu options forming part of the subset are ceased to be displayed and such as to cause display of one or more of the plurality of selectable menu options that do not form part of the subset of the selectable menu options.

8. An apparatus as claimed in claim 7, wherein the apparatus is further caused to:
evenly space displayed selectable menu options.

9. An apparatus as claimed in claim 7, wherein the apparatus is further caused to:
cause display of an indicator, the indicator indicating the number of selectable menu options that are not displayed.

10. An apparatus as claimed in claim 9, wherein the selectable menu options are arranged along an arc and wherein the indicator comprises a plurality of markers arranged in a ring, the indicator including one marker for each user-selectable option and for each hidden option.

11. An apparatus as claimed in claim 10, wherein the markers are evenly spaced around the ring.

12. An apparatus as claimed in claim 7, wherein the apparatus is further caused to:
select an option; and
in response to selection of the option, include a selectable image corresponding to the selected option in a menu.

13. A non-transitory computer-readable storage medium having stored thereon computer-readable code, which, when executed by at least one processor, cause an apparatus to at least perform:
define a plurality of selectable menu options;
cause display of an arrangement of a subset of the selectable menu options; and
cause rotation of the arrangement such that one or more of the plurality of selectable menu options forming part of the subset are ceased to be displayed and such as to cause display of one or more of the plurality of selectable menu options that do not form part of the subset of the selectable menu options.
